(19) United States
(12) Patent Application Publication
(10) Pub. No.: US 2018/0188404 A1
(43) Pub. Date: Jul. 5, 2018

(54) DEVICE FOR LOCATING OBJECT, AND METHOD FOR LOCATING OBJECT BY MEANS OF DEVICE

(71) Applicant: JINHUA MAKA TECHNOLOGY CO., LTD, YONGKANG CITY, ZHEJIANG (CN)

(72) Inventor: HONGZHOU JIANG, YONGKANG CITY, ZHEJIANG PROVINCE (CN)

(21) Appl. No.: 15/738,415

(22) PCT Filed: Aug. 18, 2015
(86) PCT No.: PCT/CN2015/087329

§ 371 Date: Dec. 20, 2017

(30) Foreign Application Priority Data
Jul. 29, 2015 (CN) 201510454439.6

(51) Int. Cl. G01V 3/10

(52) U.S. Cl. CPC G01V 3/104

(57) ABSTRACT

A device for locating an object, and a method for locating an object using the apparatus. The device comprises at least one transmission coil (100) for transmitting a measurement signal and at least one receiving coil system (200) for receiving a measurement signal, which are inductively coupled to each other, and the receiving coil system (200) is provided with at least two output stages (11, 22, 33, 44, 55, 66), the output stages (11, 22, 33, 44, 55, 66) being connected or disconnected by means of a switch device (11ᵢ⁻, 22ᵢ⁻, 33ᵢ⁻, 44ᵢ⁻, 55ᵢ⁻, 66ᵢ⁻). The method for locating an object using the device can increase the sensitivity of detection for a target object, and does not form a blind zone for measurement, which significantly improves the measurement accuracy.

### BACKGROUND OF THE INVENTION

### 1. Field of the Invention

The present invention relates to locating, and in particular, to a device for locating an object and a method for locating an object using the device.

### 2. Description of Related Art

A device for locating an object is mainly used to locate an object. There are various types of existing detectors that operate according to multiple principles. For example, a main component of the device for locating an object is a sensor, and the sensor is composed of a coil. A transmission coil is used to transmit a continuous alternating field. The alternating field is received by receiving coils. Relative to the transmission coil, the receiving coils are disposed in a way that where there is no impact by an object to be detected, induced voltages generated on the receiving coils are canceled with each other to make an induced voltage output close to 0. The magnetic impact of the transmission coil is eliminated in the receiving coils. Where there is an impact by an object to be detected, the transmission coil transmits a continuous alternating field, and an eddy current is generated in the object to be detected in the continuous alternating field. The object to be detected will change the original alternating field. More precisely, the object to be detected generates another alternating field. This alternating field may be transferred to the receiving coils, and generates induced voltages on the receiving coils. The induced voltages are amplified and correspondingly analyzed.

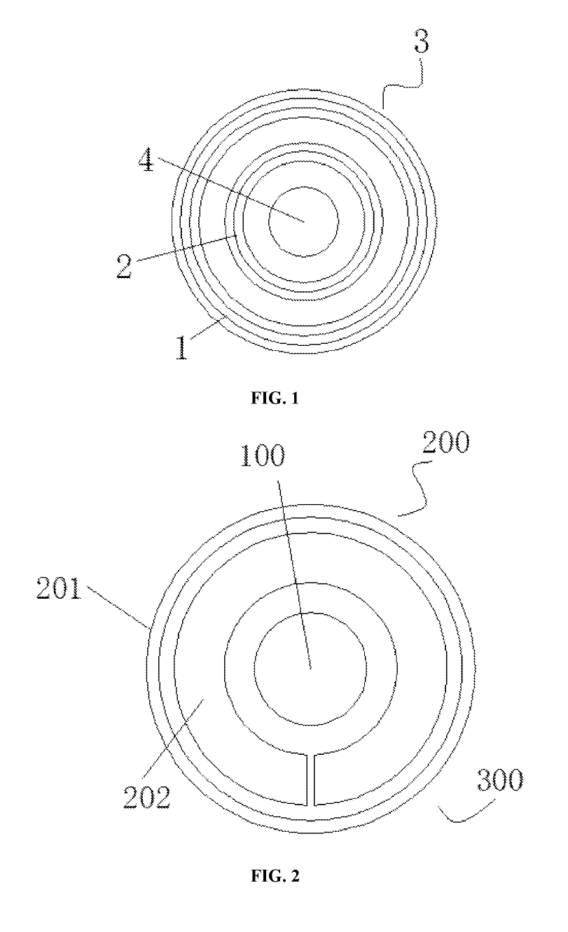

FIG. 1 is a schematic structural diagram of a device for locating an object in the prior art. A geometrical structure of the sensor is that: a receiving coil system is composed of a first receiver loop 1 and a second receiver loop 2 in opposite directions, the first receiver loop 1 and the second receiver loop 2 are coaxially disposed in a common plane 3, a transmitter coil 4 is located at a particular distance z over the common receiver plane 3, and the transmitter coil is also disposed coaxially with the first receiver loop 1 and the second receiver loop 2. In this example, if a winding of the first receiver loop 1 is disposed to be wound in a clockwise direction, then a winding of the second receiver loop 2 will be wound in a counterclockwise direction, so that voltages induced in these windings have opposite signs and can compensate each other in an absence of an external target object after appropriate sizing, and no induced voltage is output. When the device is used to locate an object, there are still the following defects. (1) The location of the transmission coil 4 changes relative to a pre-calculated location because of a tolerance during, for example, coil manufacturing or mechanical installation of the sensor. Correspondingly, a certain error voltage is induced in the first receiver loop 1 or the second receiver loop 2, which causes an error to a measurement result in direct measurement, thereby affecting the measurement accuracy. Therefore, an error voltage is adjusted by adding a compensation coil that is in a same direction as one of the first receiver loop 1 and the second receiver loop 2. Because the error voltage is indefinite, accurate adjustment cannot be performed by the method. That is, the error voltage cannot be completely eliminated or compensated, resulting in low sensitivity. In addition, with the compensation, a space on a circuit board is necessarily occupied. In some cases, for better adjustment, the size of the circuit board requires to be increased, resulting in high costs and space occupation. Furthermore, because the first receiver loop 1 and the second receiver loop 2 are disposed in opposite directions, in actual adjustment, an induced voltage can only be unidirectionally adjusted, resulting in low adjustment accuracy. (2) Theoretically, when no metal object exists, induced voltages in the first receiver loop 1 and the second receiver loop 2 are exactly canceled with each other. However, in practice, because of the impact of factors such as noise of a power supply, noise of an operational amplification circuit, temperature, and humidity, the error voltage always exists. Moreover, because of randomness of the noise and randomness of a transmission coil, the change of an induced voltage is random, and complete compensation is difficult to achieve by means of a compensation coil.

### SUMMARY OF THE INVENTION

The present invention, for the deficiencies in the prior art, provides a device for locating an object and a method for locating an object using the device. The present invention can improve sensitivity of detecting a target object, and does not form a blind zone for measurement, thereby significantly improving the measurement accuracy.

To solve the foregoing technical problem, the present invention adapts the following technical solutions:

A device for locating an object has at least one transmission coil for transmitting a measurement signal and at least one receiving coil system for receiving a measurement signal, inductively coupled to each other. At least two output stages are disposed on the receiving coil system, and the output stages are connected or disconnected by means of a switch device.

Further, the receiving coil system includes at least one first receiving coil and at least one second receiving coil located in a same plane, and at least two output stages are respectively disposed on the first receiving coil and the second receiving coil.

Further, an induced voltage between output stages that are farthest away from each other on the second receiving coil is substantially equal to an induced voltage between two output stages that are closest to each other on the first receiving coil; or an induced voltage between output stages that are farthest away from each other on the first receiving coil is substantially equal to an induced voltage between two output stages that are closest to each other on the second receiving coil.

Further, the transmission coil forms a projection on the plane, an area formed by the first receiving coil on the plane contains the projection, an area formed by the second receiving coil on the plane is disposed around the projection, the first receiving coil is electrically connected to the second receiving coil, and the first receiving coil and the second receiving coil have a same winding direction.

Preferably, the area formed by the first receiving coil on the plane completely contains the projection.

Preferably, the area formed by the first receiving coil on the plane partially contains the projection.

Preferably, one area is formed by the second receiving coil on the plane, and the area surrounds the projection with an opening.

Preferably, at least two areas are formed by the second receiving coil on the plane, and the areas are sequentially distributed around the projection.

Preferably, the switch device is an MOS transistor or a bipolar transistor.

A method for locating an object using the foregoing device is as follows.

The device is operated when no object to be located exists. Amplitudes of output signals of the output stages are sequentially detected by means of switch devices, and switch device setting information is stored. The switch device setting information is on/off status information of the switch devices corresponding to an output signal with a minimum amplitude that is selected by comparing the amplitudes of the output signals. The switch devices are controlled according to the switch device setting information to be turned on or turned off. Thus, the device is operated to locate an object.

Further, the switch device setting information has n*m states, where n is the number of output stages on the first receiving coil, and m is the number of output stages on the second receiving coil.

The present invention achieves the following advantageous effects.

(1) When an object is located by the locating method, an error voltage value caused by factors such as a process, an environmental condition or even a coil winding does not need to be compensated. The switch device setting information is a status of a switch device corresponding to a minimum amplitude selected by comparing the amplitudes of the output signals, and the status is stored in a nonvolatile memory. In a next operation, a status of a switch is read directly from the nonvolatile memory, thereby improving the sensitivity of detection for a target object. (2) In the present invention, a large number of turns of coils may be disposed in a relatively small area for the first receiving coil and the second receiving coil, and switch devices are disposed at different coil locations of the first receiving coil and the second receiving coils. In this way, calibration can be performed in a relatively large range, the space is significantly saved, and the adjustment accuracy is improved. Moreover, bidirectional calibration may be achieved for an induced voltage, thereby significantly improving the adjustment accuracy.

Additional aspects and advantages of the present invention will be partially given in the following description, and will partially become apparent from the following description or be understood from the practice of the present invention.

### DETAILED DESCRIPTION OF THE PREFERRED EMBODIMENTS

The accompanying drawings are included to provide a further understanding of the invention and constitute a part of this application. The exemplary embodiments and description thereof of the invention serve to explain the present invention and are not intended to limit the invention in any way. In the drawings:

FIG. 1 is a schematic structural diagram of the prior art;

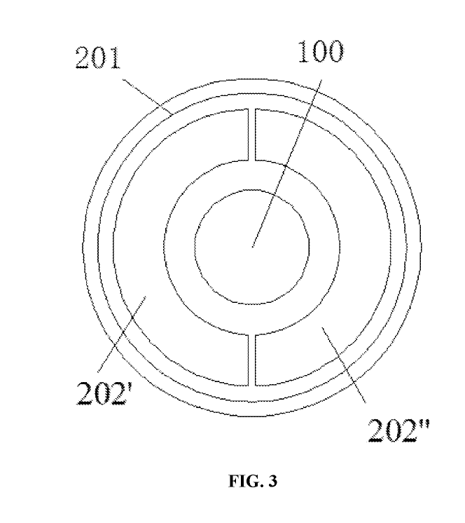

FIG. 2 is a schematic structural diagram according to Embodiment 1 of a device for locating an object of the present invention;

FIG. 3 is a schematic structural diagram according to Embodiment 2 of a device for locating an object of the present invention;

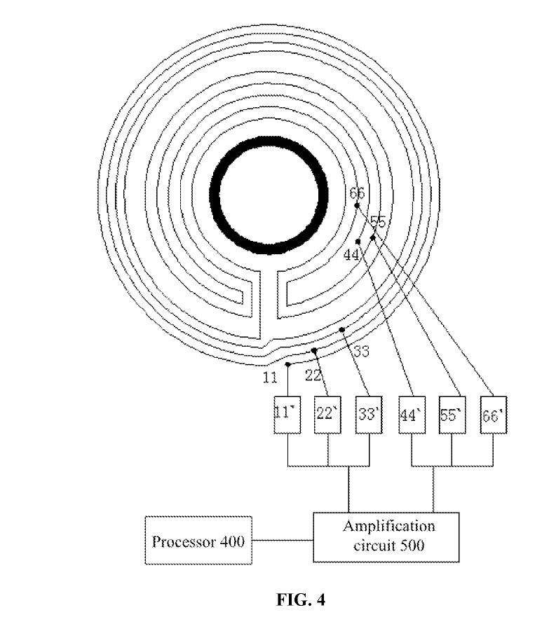

FIG. 4 is a schematic diagram of detection according to Embodiment 1 of a device for locating an object of the present invention;

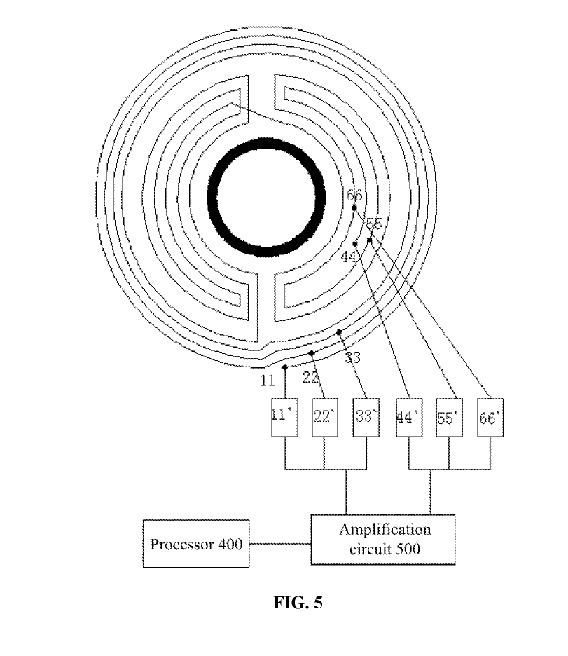

FIG. 5 is a schematic diagram of detection according to Embodiment 2 of a device for locating an object of the present invention;

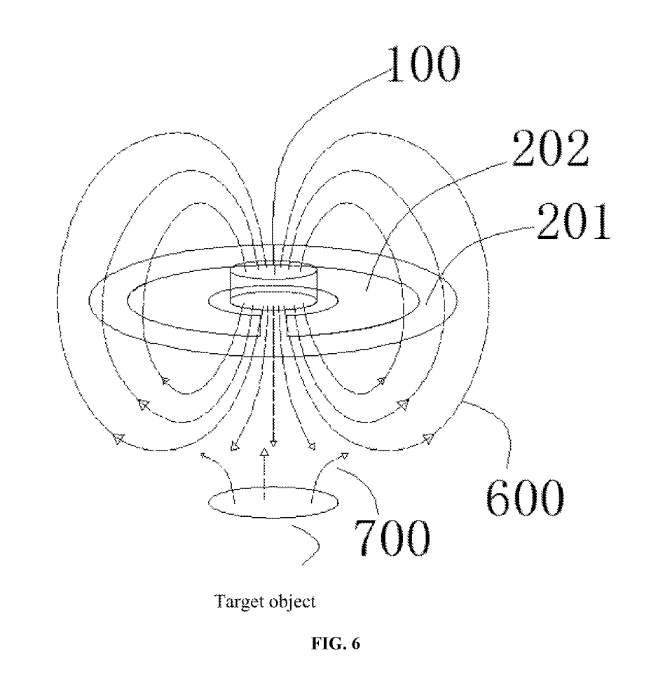

FIG. 6 is a principle diagram of a geometrical structure according to Embodiment 1 of a device for locating an object of the present invention; and

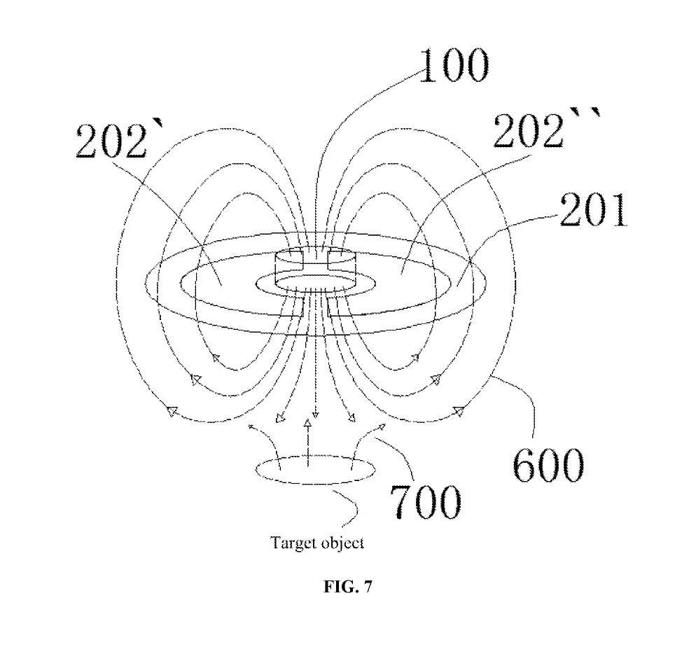

FIG. 7 is a principle diagram of a geometrical structure according to Embodiment 2 of a device for locating an object of the present invention.

### DETAILED DESCRIPTION OF THE PREFERRED EMBODIMENTS

In order to make the objectives, technical solutions, and advantages of embodiments of the present invention clearer, the technical solutions of embodiments of the present invention are clearly and completely described below with reference to the accompanying drawings of embodiments of the present invention. It is obvious that the described embodiments are merely some rather than all embodiments of the present invention. Based on the described embodiments of the present invention, all other embodiments obtained by persons of ordinary skill in the art without making creative efforts shall fall within the protection scope of the present invention.

In the description of the present invention, it is to be understood that orientation or positional relations indicated by terms “center”, “longitudinal”, “transverse”, “length”, “width”, “thickness”, “up”, “down”, “front”, “rear”, “left”, “right”, “vertical”, “horizontal”, “top”, “bottom”, “inner”, “outer”, “clockwise”, “counter-clockwise” and the like are based on those shown in the accompanying drawings, and they are only intended to facilitate and simplify the description of the present invention, rather than indicating or implying that a device or element indicated by the terms must have a particular orientation, or must be configured and operated at a particular orientation, and thus should not be construed as limiting the present invention.

In the description of the present invention, unless explicitly specified and defined otherwise, terms “mount”, “connect”, “connection”, “fix” and the like should be interpreted in a broad sense, and may be, for example, a fixed connection, removable connection or integral connection; may also be a mechanical connection or electrical connection; may be a direct connection or indirect connection via an intermediate medium; may also be communication between interiors of two elements. Those of ordinary skill in the art may understand specific meanings of the above-mentioned terms in the present invention according to specific situations.

In the present invention, unless explicitly specified and defined otherwise, a first feature being “above” or “below” a second feature may include the first feature and the second feature being in direct contact, and may also include the first feature and the second feature being in non-direct contact via another feature therebetween. Further, the first feature being “over”, “above” or “on the top of” the second feature includes the first feature being directly above and obliquely above the second feature, or merely indicates the horizontal height of the first feature being higher than that of the second feature. The first feature being “under”, “below” or “underneath” the second feature includes the first feature being directly below and obliquely below the second feature, or merely indicates that the horizontal height of the first feature is lower than that of the second feature.

Unless defined otherwise, all technical and scientific terms used herein have the same meanings as commonly understood by one of ordinary skill in the art to which the present invention belongs. The terms “first”, “second”, and the like herein in the description and in the claims do not denote any order, quantity, or importance, but rather are used to distinguish one element from another. Similarly, the use of the terms a, an, etc. do not denote a limitation of quantity, but rather denote the presence of at least one of the referenced item.

It is well known to those skilled in the art that the term “field lines” should not be understood literally, because to some extent, the “field lines” only simply represent areas with the same magnetic strength and polarity. For this reason, in the following description of the present invention, this term is used to represent magnetic density. For better description, only one winding is used to represent a coil. It will be easily understood that in the present invention, it is considered that a starting coil has multiple windings, or coils are “printed” on a board.

As shown in FIG. 2 to FIG. 4, as an embodiment of the present invention, a device for locating an object has at least one transmission coil 100 for transmitting a measurement signal and at least one receiving coil system 200 for receiving a measurement signal, inductively coupled to each other. This embodiment is described below with one transmission coil 100 and one receiving coil system 200 as an example. The receiving coil system 200 in this embodiment includes at least one first receiving coil 201 and at least one second receiving coil (202, 202′, 202″) located in a same plane 300. The transmission coil 100 forms a projection on the plane 300. An area formed by the first receiving coil 201 on the plane 300 contains the projection, and an area formed by the second receiving coil 202 on the plane 300 is disposed around the projection. The first receiving coil 201 is electrically connected to the second receiving coil 202. At least two output stages are respectively disposed on the first receiving coil 201 and the second receiving coil (202, 202′, 202″), and the output stages are connected or disconnected by means of a switch device.

As an embodiment of the present invention, as shown in FIG. 2, a greatly simplified principle diagram shows a first embodiment of a geometrical structure of a device for locating a metal object. The device has one transmission coil 100 and one receiving coil system 200 inductively coupled to each other. In this embodiment, one transmission coil 100 and one receiving coil system 200 are used as an example for description. However, the sensor of the present invention is not limited thereto. The receiving coil system 200 in the present invention includes one first receiving coil 201 and one second receiving coil 202 located in a same plane. The transmission coil 100 forms a projection on the plane. An area formed by the first receiving coil 201 on the plane completely contains the projection, or may also partially contain the projection. One area is formed by the second receiving coil 202 on the plane, and the area surrounds the projection with an opening. The first receiving coil 201 is electrically connected to the second receiving coil 202. Similarly, the receiving coil system 200 is not limited to including one first receiving coil 201 and one second receiving coil 202 located in a same plane, and may include two or more first and second receiving coils.

As an embodiment of the present invention, as shown in FIG. 3, a greatly simplified principle diagram shows a second embodiment of a geometrical structure of a device for locating a metal object. The device has one transmission coil 100 and one receiving coil system 200 inductively coupled to each other. In this embodiment, one transmission coil 100 and one receiving coil system 200 are used as an example for description. However, the sensor of the present invention is not limited thereto. The receiving coil system 200 in the present invention includes one first receiving coil 201 and one second receiving coil located in a same plane. The transmission coil 100 forms a projection on the plane. An area formed by the first receiving coil 201 on the plane completely contains the projection, or may also partially contain the projection. For the second receiving coil, two areas are formed on the plane by second receiving coils (202′, 202″), and the areas are sequentially distributed around the projection. The first receiving coil 201 is electrically connected to the second receiving coils (202′, 202″). Similarly, the receiving coil system 200 is not limited to including one first receiving coil 201 and two second receiving coils (202′, 202″) located in a same plane, and may include three or more first and second receiving coils.

In this embodiment, as shown in FIG. 3, an optimal layout is that a group of the second receiving coils (202′, 202″) are distributed symmetrically about the transmission coil 100. Various factors such as humidity and temperature affect a magnetic field of the transmission coil 100, and the symmetrical distribution is helpful to neutralize such impact, although neutralization of such impact may also be effected with an asymmetrical distribution. During specific implementation, the sensitivity of measurement can be improved when the number of turns in the receiving coil system such as the first receiving coil 201 or the second receiving coil (202, 202′, 202″) and the area included by the coils are increased while maintaining the balance of induced voltages.

The transmission coil 100 in this embodiment may be located at a particular distance over the common receiving plane, and is disposed in parallel with the receiving coil system 200. At least two positioning holes for fixedly installing the transmission coil 100 are disposed on a printed circuit board, and pins of the transmission coil 100 are inserted in the positioning holes and are welded on the circuit board. The transmission coil 100 may also be a lead structure directly disposed on a printed circuit board or be embedded in the printed circuit board.

In the present invention, the first receiving coil 201 and the second receiving coil 202 have a same winding direction. As shown in FIG. 2 and FIG. 3, for a second alternating magnetic field generated by a target object, a positive electrode of an induced voltage of the first receiving coil 201 is connected to a negative electrode of an induced voltage of the second receiving coil (202, 202′, 202″), just like a connection of positive and negative electrodes of multiple batteries. In this way, the induced voltages of the two coils may be added. As can be seen from the connection, as shown in FIG. 6 and FIG. 7, voltages induced in the receiving coils by a first magnetic field 600 can be canceled by this connection, and voltages induced by a second magnetic field 700 are superimposed. Therefore, not only the induced voltage induced by the first magnetic field 600 can be canceled, but also the induced voltage induced by the second magnetic field 700 can be increased, thereby significantly improving the sensitivity of detection.

In this embodiment, as shown in FIG. 4, a black dot in the figure represents a connecting point, that is, an output stage. An output stage is generally disposed at a start and an end of a coil. In the figure, at least one connecting point is generally disposed on the first receiving coil 201. If one connecting point is disposed, the connecting point is usually disposed at a starting location of the coil. When more points are disposed, a range of calibration may definitely be larger. Generally, three points are preferably disposed. According to Embodiment 1, three output stages (11, 22, 33) are disposed on the first receiving coil 201. When a gap between locations of the output stages is smaller, the accuracy of calibration is higher. Generally, the gap between the output stages is preferably about one turn, and the gaps are kept consistent. In the figure, at least one connecting point is generally disposed on the second receiving coil 202. If one connecting point is disposed, the connecting point is generally disposed at an end location of the coil. Generally, about 3 to 10 connecting points are disposed. According to Embodiment 1, three output stages (44, 55, 66) are disposed on the second receiving coil 202. For a better calibration effect, when no metal exists, an induced voltage between output stages that are farthest away from each other on the second receiving coil is substantially equal to an induced voltage between two output stages that are closest to each other on the first receiving coil; or an induced voltage between output stages that are farthest away from each other on the first receiving coil is substantially equal to an induced voltage between two output stages that are closest to each other on the second receiving coil. When a gap between locations of connecting points on the second receiving coil is smaller, the accuracy of calibration is higher. In this case, more connecting points are needed. Generally, the gap between the output stages is preferably about one turn, and gaps are kept consistent.

The three output stages (11, 22, 33) on the first receiving coil 201 are respectively connected to one ends of switch devices (11′, 22′, 33′), and the other ends of the three switch devices are connected together and are connected to an input of an amplification circuit 500. An output of the amplification circuit 500 is connected to a processor 400. The switch device in this embodiment is generally an MOS transistor or a bipolar transistor. The processor 400 controls the switch device to be turned off or turned on. In this embodiment, one capacitor is connected in series at the input of the amplification circuit 500, so that the impact of direct current signals of the switch devices (11′, 22′, 33′) can be reduced. For an amplifier in this embodiment, an operational amplifier having high input impedance, low noise, and low temperature drift is generally selected.

Similarly, the three output stages (44, 55, 66) on the second receiving coil 202 are respectively connected to one ends of switch devices (44′, 55′, 66′), and the other ends of the three switch devices are connected together and are connected to the input of the amplification circuit 500. The output of the amplification circuit 500 is connected to the processor 400.

The device is operated when no object to be located exists. Amplitudes of output signals of the output stages are sequentially detected by means of switch devices, and switch device setting information is stored. The switch device setting information is on/off status information of the switch devices corresponding to an output signal with a minimum amplitude that is selected by comparing the amplitudes of the output signals. The processor 400 controls, according to the switch device setting information, the switch devices to be turned on or turned off. Thus, the device is operated to locate an object.

A process of specific implementation is as follows.

When no object exists, the transmission coil 100 is driven to generate an alternating magnetic field, and the processor 400 detects the amplitude of an output signal of the amplification circuit 500:

turning on the switch device 11′ and the switch device 44′, and turning off the rest switch devices, to detect an amplitude A1 of an output signal of the amplification circuit 500;

turning on the switch device 11′ and the switch device 55′, and turning off the rest switch devices, to detect an amplitude A2 of an output signal of the amplification circuit 500;

turning on the switch device 11′ and the switch device 66′, and turning off the rest switch devices, to detect an amplitude A3 of an output signal of the amplification circuit 500;

turning on the switch device 22′ and the switch device 44′, and turning off the rest switch devices, to detect an amplitude B1 of an output signal of the amplification circuit 500;

turning on the switch device 22′ and the switch device 55′, and turning off the rest switch devices, to detect an amplitude B2 of an output signal of the amplification circuit 500;

turning on the switch device 22′ and the switch device 66′, and turning off the rest switch devices, to detect an amplitude B3 of an output signal of the amplification circuit 500;

turning on the switch device 33′ and the switch device 44′, and turning off the rest switch devices, to detect an amplitude C1 of an output signal of the amplification circuit 500;

turning on the switch device 33′ and the switch device 55′, and turning off the rest switch devices, to detect an amplitude C2 of an output signal of the amplification circuit 500; and

turning on the switch device 33′ and the switch device 66′, and turning off the rest switch devices, to detect an amplitude C3 of an output signal of the amplification circuit 500.

The minimum amplitude is calculated, a status of a corresponding switch device is obtained, and the status is stored in a nonvolatile memory. In a next operation, a status of a switch is read directly from the nonvolatile memory, thereby significantly improving the sensitivity of detection for a target object. The status of the switch device in this embodiment has n*m states, where n is the number of connecting points on the first receiving coil, and m is the number of connecting points on the second receiving coil.

In this embodiment, as shown in FIG. 5, for the device in Embodiment 2, because the second receiving coil 202′ and the second receiving coil 202″ are disposed generally symmetrically, an output terminal of the second receiving coil 202′ is electrically connected to an input terminal of the second receiving coil 202″. Other principles are the same as those in the foregoing Embodiment 1, and details are no longer described here.

In general, in the present invention, a large number of turns of coils may be disposed in a relatively small area for the first receiving coil 201 and the second receiving coil, and switch devices are disposed at different coil locations of the first receiving coil 201 and the second receiving coils (202, 202′, 202″). In this way, calibration can be performed in a relatively large range, the space is significantly saved, the number of disposed switches may be increased, and the adjustment accuracy is improved. Moreover, bidirectional calibration may be achieved for the first receiving coil 201 and the second receiving coils (202, 202′, 202″), thereby significantly improving the adjustment accuracy.

It should be noted that the foregoing embodiments are merely intended for describing the technical solutions of the present invention rather than limiting the present invention. Although the present invention has been described in detail with reference to the foregoing embodiments, persons of ordinary skill in the art should understand that modifications may be made to the technical solutions described in the foregoing embodiments or equivalent substitutions are made to some technical features therein, and these modifications or substitutions do not cause the essence of respective technical solutions to depart from the scope of the technical solutions of the embodiments of the present invention.

In summary, the foregoing is merely preferred embodiments of the present invention. Any equivalent variations and modifications made according to the claims of the present invention shall fall within the scope of the present invention.

1. A device for locating an object, having at least one transmission coil for transmitting a measurement signal and at least one receiving coil system for receiving a measurement signal, inductively coupled to each other, wherein at least two output stages are disposed on the receiving coil system, and the output stages are connected or disconnected by means of a switch device.

2. The device for locating an object according to claim 1, wherein the receiving coil system comprises at least one first receiving coil and at least one second receiving coil located in a same plane, and at least two output stages are respectively disposed on the first receiving coil and the second receiving coil.

3. The device for locating an object according to claim 2, wherein an induced voltage between output stages that are farthest away from (or closet to) each other on the second receiving coil is substantially equal to an induced voltage between two output stages that are closest to (or farthest away from) each other on the first receiving coil.

4. The device for locating an object according to claim 1, wherein the transmission coil forms a projection on the plane, an area formed by the first receiving coil on the plane contains the projection, an area formed by the second receiving coil on the plane is disposed around the projection, the first receiving coil is electrically connected to the second receiving coil, and the first receiving coil and the second receiving coil have a same winding direction.

5. The device for locating an object according to claim 4, wherein the area formed by the first receiving coil on the plane completely contains the projection.

6. The device for locating an object according to claim 4, wherein the area formed by the first receiving coil on the plane partially contains the projection.

7. The device for locating an object according to claim 7, wherein one area is formed by the second receiving coil on the plane, and the area surrounds the projection with an opening.

8. The device for locating an object according to claim 7, wherein at least two areas are formed by the second receiving coil on the plane, and the areas are sequentially distributed around the projection.

9. The device for locating an object according to claim 1, wherein the switch device is an MOS transistor or a bipolar transistor.

10. A method for locating an object using the device according to any one of claims 1 to 25, wherein
the device is operated when no object to be located exists, amplitudes of output signals of the output stages are sequentially detected by means of switch devices, and switch device setting information is stored, the switch device setting information being on/off status information of the switch devices corresponding to an output signal with a minimum amplitude that is selected by comparing the amplitudes of the output signals;
and the switch devices are controlled according to the switch device setting information to be turned on or turned off, whereby the device is operated to locate an object.

11. The method according to claim 26, wherein the switch device setting information has n*m states, where n is the number of output stages on the first receiving coil, and m is the number of output stages on the second receiving coil.

12. The device for locating an object according to claim 2, wherein the transmission coil forms a projection on the plane, an area formed by the first receiving coil on the plane contains the projection, an area formed by the second receiving coil on the plane is disposed around the projection, the first receiving coil is electrically connected to the second receiving coil, and the first receiving coil and the second receiving coil have a same winding direction.

13. The device for locating an object according to claim 3, wherein the transmission coil forms a projection on the plane, an area formed by the first receiving coil on the plane contains the projection, an area formed by the second receiving coil on the plane is disposed around the projection, the first receiving coil is electrically connected to the second receiving coil, and the first receiving coil and the second receiving coil have a same winding direction.

14. The device for locating an object according to claim 5, wherein the area formed by the first receiving coil on the plane completely contains the projection.

15. The device for locating an object according to claim 6, wherein the area formed by the first receiving coil on the plane completely contains the projection.

16. The device for locating an object according to claim 5, wherein the area formed by the first receiving coil on the plane partially contains the projection.

17. The device for locating an object according to claim 6, wherein the area formed by the first receiving coil on the plane partially contains the projection.

18. The device for locating an object according to claim 8, wherein one area is formed by the second receiving coil on the plane, and the area surrounds the projection with an opening.

19. The device for locating an object according to claim 9, wherein one area is formed by the second receiving coil on the plane, and the area surrounds the projection with an opening.

20. The device for locating an object according to claim 10, wherein one area is formed by the second receiving coil on the plane, and the area surrounds the projection with an opening.

21. The device for locating an object according to claim 11, wherein one area is formed by the second receiving coil on the plane, and the area surrounds the projection with an opening.

22. The device for locating an object according to claim 12, wherein one area is formed by the second receiving coil on the plane, and the area surrounds the projection with an opening.

23. The device for locating an object according to claim 8, wherein at least two areas are formed by the second receiving coil on the plane, and the areas are sequentially distributed around the projection.

24. The device for locating an object according to claim 9, wherein at least two areas are formed by the second receiving coil on the plane, and the areas are sequentially distributed around the projection.

25. The device for locating an object according to claim 10, wherein at least two areas are formed by the second receiving coil on the plane, and the areas are sequentially distributed around the projection.

26. The device for locating an object according to claim 11, wherein at least two areas are formed by the second receiving coil on the plane, and the areas are sequentially distributed around the projection.

27. The device for locating an object according to claim 12, wherein at least two areas are formed by the second receiving coil on the plane, and the areas are sequentially distributed around the projection.
